(19) United States
(12) Patent Application Publication
(10) Pub. No.: US 2008/0070649 A1
(43) Pub. Date: Mar. 20, 2008

(54) Free Space Optical Interconnections in Cellular Telephone Handsets

(76) Inventor: Toshi K. Uchida, Rolling Hills Estates, CA (US)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(21) Appl. No.: 11/470,441

(22) Filed: Sep. 6, 2006

(51) Int. Cl. H04M 1/00

(52) U.S. Cl. 455/575.4

(57) ABSTRACT

High data rate interconnections between foldable parts of a cellular telephone handset, such as the handset keypad and handset display portions, are made by free space optical data transmission between light emitting devices such as laser diodes or LEDs and photodiodes, without use of optical waveguides or cables between the foldable parts.

### BACKGROUND OF THE INVENTION

1. Field of the Invention

This invention pertains to the field of communications handsets such as are used for cellular telephony and more particularly relates to optical couplings between relatively movable portions of the handsets.

2. State of the Prior Art

Recently, mobile telephone handsets have evolved beyond mere telephones, and many now include a digital camera, a high resolution TV player, a video phone, a digital music player, and an internet browsing device. Mobile telephone manufacturers are currently designing a next generation (known as Generation 3.5 or Generation 4) of high performance telephone handsets.

To make the handsets more compact and easier to carry, cellphone handsets have been designed with handset portions which are moveable relative to each other between a compact closed configuration and a deployed configuration. For example, the radio transmitter and receiver are housed in a cellphone body which also carries a keypad, while one or more display screens, and now a digital camera, are mounted on a display unit which is attached mechanically and electrically to the cellphone body. Two popular configurations include the flip open or clamshell style handset where the display unit is hinged to the cellphone body, and the slide style handset where the display portion slides linearly in relation to the cellphone body between a closed condition where the display portion entirely covers the keyboard of the body portion and an extended condition where the keyboard is exposed for access.

Such two part cellphone handsets require a means for interconnecting the display screen or screens and the digital camera to the receiver, transmitter and other circuits in the cellphone body. In the past, this interconnection was made with electrically conductive wiring such as a coaxial cable or a ribbon cable. However, with increasing data transfer rates between the interconnected portions of the handset, the traditional electrical connections are proving inadequate.

Ordinary electrical flexible cable may be vulnerable to EMI (electromagnetic interference noise) and/or the electronic cable can be inadequate for the data rates above 1 Gb/s which are required by the newer handsets.

To meet this challenge many cellphone manufacturing companies are developing flexible optical cable for making the interconnection between the body and display portions as a replacement for the electrical cable. However, the requirements on the optical cable or fiber interconnection are very tight, particularly as to mechanical reliability under repeated flexing and bending (in terms of optical cable bending frequency and bending radius) and the thickness of the optical cable (thinner is better given the small dimensions of typical handsets). Moreover, mobile phone handsets must be cheap, so that economy of parts and cost of assembly are important.

### SUMMARY OF THE INVENTION

The aforementioned difficulties are addressed in the present invention by using free space optical transmission of data between the cellphone body and display units and eliminating the need for a cable connection between those elements. That is, optical data links are established without interconnecting waveguides, e.g. across free space or air gaps, between circuits of a communications handset and in particular between portions of the handset which are movable relatively to each other in foldable, collapsible or deployable handsets.

According to this invention a communications handset of the type having first and second handset portions mutually displaceable between a closed condition and a deployed condition and having electronic circuits in each of the portions is improved by providing at least one light emitting device and at least one light detecting device on each of the handset portions. The emitting and detecting devices are connected to the circuits on their respective portions and are optically aligned across a free space in the closed condition and the deployed condition of the handset for providing optical transfer of data between the electronic circuits of the two handset portions.

In one form of the invention the first handset portion is a body portion with a keypad and the second handset portion is a display portion hinged to the body portion for movement between the closed condition and the deployed condition.

In another form of the invention the first handset portion is a body portion with a keypad and the second portion is a display portion linearly slidable relative to the body portion between the closed condition and the deployed condition.

In one embodiment of the invention, a first light emitting device and a first light detecting device is provided on each of the portions in optical alignment for providing data transfer in the closed condition of the handset and a second light emitting device and a second light detecting device is provided on each of the portions in optical alignment for providing data transfer in the deployed condition of the handset.

In another embodiment of the invention wherein the handset portions are hinged to each other, the light emitting devices and light detecting devices are optically aligned axially to the hinge.

These and other features, improvement and advantages of the present invention will be better understood from the following detailed description in conjunction with the accompanying drawings.

### BRIEF DESCRIPTION OF THE DRAWINGS

FIG. 1 is a perspective view of a typical flip-open or clamshell type cellular telephone handset, shown in closed condition with the display portion folded over the main body portion of the unit;

FIG. 2 is a perspective view of the handset of FIG. 1 shown in open condition with the display portion deployed away from the main body portion of the unit;

FIG. 2a is a schematic view illustrating the arrangement of the photo emitters and photo detectors in an open condition of the handset of FIG. 2;

FIG. 3 is a side schematic view of the closed handset of FIG. 1 with an optical transmitter/receiver pair indicated by small rectangular boxes;

FIG. 4 is a side schematic view as in FIG. 3 but with the handset open as in FIG. 2 and showing the optical transmitter/receiver pair aligned for data communication between the deployed display portion and the main body portion;

FIG. 5 is a fragmentary close up view of the hinge joining the main body portion to the display portion of the handset unit of FIG. 1, illustrating another possible arrangements of two optical transmitter/receiver pairs aligned axially to the hinge;

FIG. 6 is a top side perspective view of a slide-to-open type cellular telephone handset, shown in closed condition with the display portion retracted over the main body portion of the unit;

FIG. 7 is a perspective view of the handset of FIG. 6 shown in open condition with the display portion extended from the main body portion of the unit;

FIG. 8 is a diagram illustrating one possible arrangement of optical transmitter/receiver pairs in the handset of FIGS. 6 and 7;

### DETAILED DESCRIPTION OF THE PREFERRED EMBODIMENTS

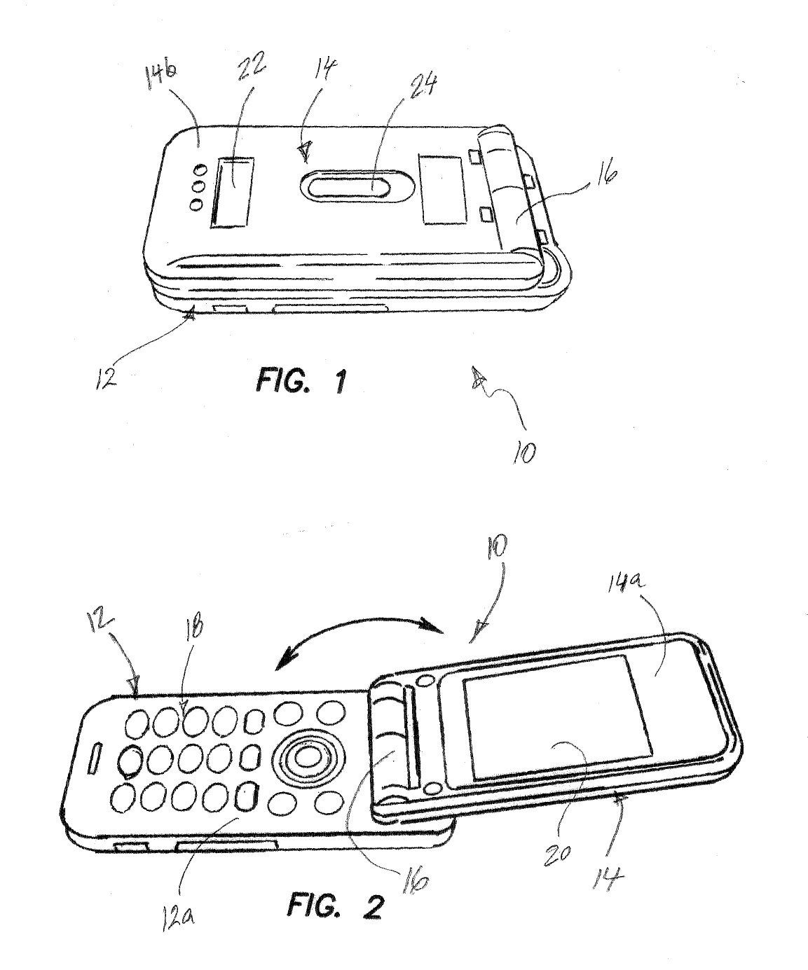

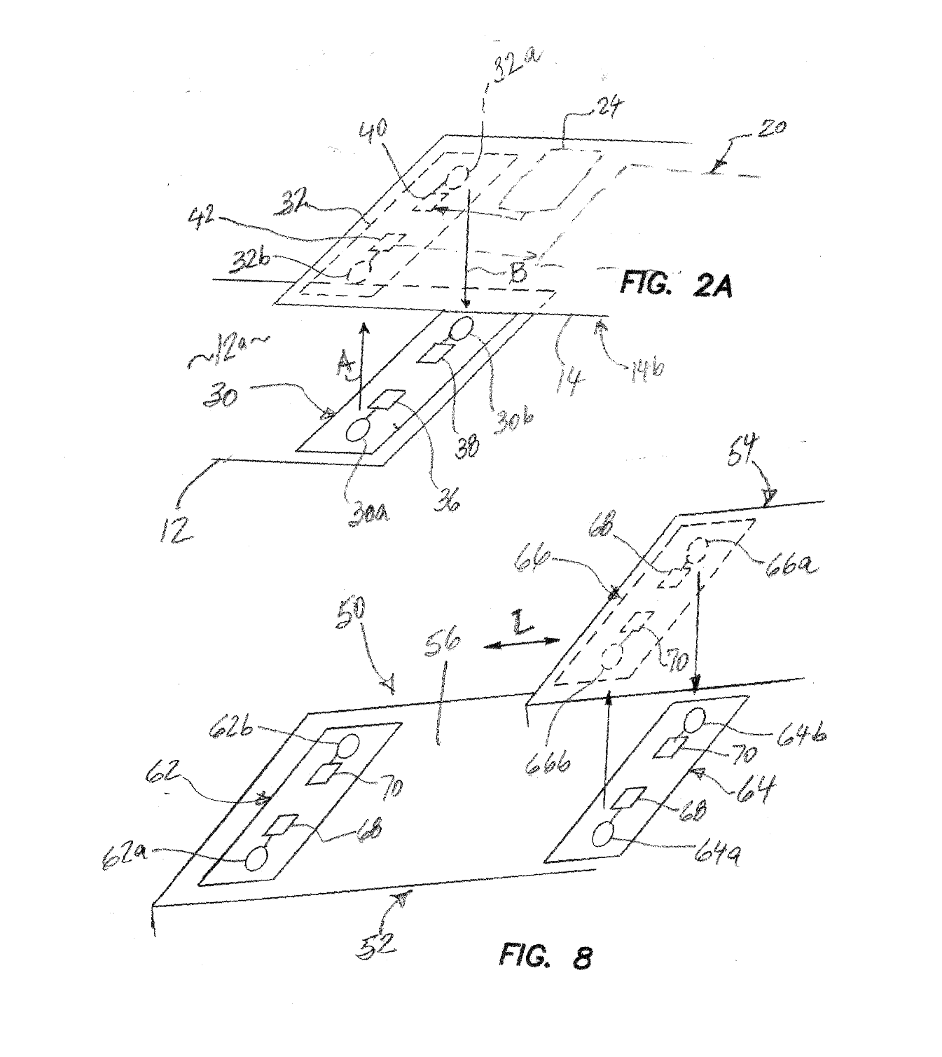

With reference to the drawings in which like elements are indicated by like numerals, FIG. 1 illustrates a typical flip-open or clamshell type cellular telephone handset generally designated by numeral 10 and which has a main body portion 12 and a display portion 14 joined to each other by a hinge 16. The body portion 12 and display portion 14 have internal surfaces 12a, 14a respectively which are mutually opposing in the closed condition of the unit 10 shown in FIG. 1. When the handset 10 is deployed to its open condition seen in FIG. 2 the internal surfaces 12a, 14a both face approximately towards the same direction, and in practice face towards the user or holder of the handset.

In most communications handsets of this type the main body portion 12 contains and houses a radio transceiver which receives and transmits radio signals over the air, a battery for powering the various circuits and systems of the handset 10, and a keypad 18, among still other devices. The display portion 14 normally includes an LCD (liquid crystal display) screen 20 on the internal surface 14a and often a second smaller outer LCD screen 22 on an exterior surface 14b. The exterior display 22 typically shows handset status, caller identification and other information while the handset 10 is closed. In many newer handsets, a still or video camera 24 is provided on the display portion 14, which displays captured images on LCD 20 and is also connected to the radio transceiver and other circuits in the main body 12 so that the images can be sent to other handsets through the radio communications network or downloaded, e.g., to a computer.

Both LCDs 20, 22 and the camera 24 on the display portion 14 require interconnection for data transfer to and from the circuits of the body portion 12. According to this invention, this interconnection is provided at least in part by optical links without use of a physical connection or optical waveguide, such as across a free space or air gap, between one or more light emitter/detector pairs.

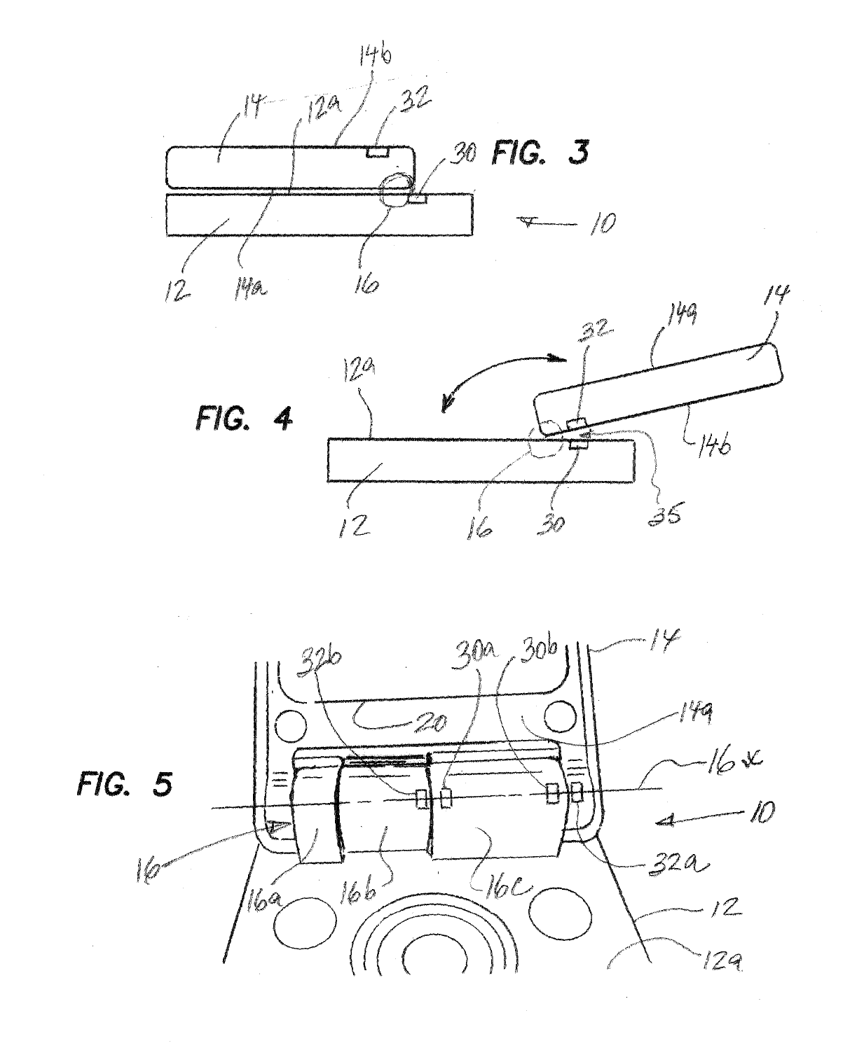

FIG. 3 illustrates in schematic form a flip-open style handset 10 shown closed with display portion 14 folded over the body portion 12. A first photo emitter/photo detector set 30 is mounted on interior surface 12a of body portion 12 and a second photo emitter/photo detector set 32 is mounted on the exterior surface 14b of the display portion 14. In the closed condition of FIG. 3, the second emitter/detector set 32 faces away from body portion 12, while the first emitter/detector set 30 faces up from body portion 12 towards display portion 14. Also, in the closed condition of FIG. 3 the second set 32 is laterally offset, to the left in FIG. 3, relative to the first set 30. When the handset 10 is deployed to the open condition of FIG. 4 by rotation of the display portion 14 about a hinge 16 relative to the body portion 12, the first and second photo emitter/detector sets 30/32 come into optical alignment with each other, such that the photo emitter of one set is optically aligned with the photo detector of the other set. By deploying the display portion 14 the second emitter/detector set 32 swings through an arc of about 180 degrees from an upwardly facing position in FIG. 3 to a downwardly facing position in FIG. 4, and also moves from its initial, inoperative offset position to an operative position overlying the first emitter/detector set 30. The optical links are established between the photo emitter/detector pairs without need for flexible optical cable.

The arrangement of the photo emitter/detector sets 30, 32 in the aligned operative position may be better understood from FIG. 2a. The first emitter/detector pair 30 includes photo emitter 30a and photo detector 30b. The second emitter/detector pair 32 includes photo emitter 32a and photo detector 32b. Photo emitter 30a is electrically driven by a driver integrated circuit 36 installed in body portion 12 for converting electronic data signals provided by electronic circuits in the body portion into optical signals which are then emitted by photo emitter 30a towards photo detector 32b of the overlying second emitter/detector set 32, as suggested by arrow A. Photo detector 32b receives the optical signals from photo emitter 30a and converts them into electrical signals which are processed by receiver integrated circuit 42 installed in display portion 14. The processed signals can then be supplied to LCD display 20. Digital data signals from camera 24 are supplied to transmitter driver integrated circuit 40 which drives photo emitter 32a. Photo emitter 32a on the display portion 14 converts the electrical drive signals from driver IC 40 into light signals encoded with data from camera 24 and emits the optical light signal towards photo detector 30b on the body portion 12, as suggested by arrow B, where the received optical signal is converted back to an electrical signal by receiver integrated circuit 38, which processes the signals and supplies them to the appropriate circuits in the body portion 12.

The photo emitter 30a and photo detector 32b form one photo emitter/detector pair, providing data transmission from the body portion 12 to the display portion 14. Photo emitter 32a and photo detector 30b form a second photo emitter/detector pair, providing data transmission from the display portion 14 to the body portion 12. The optical links provided by each photo emitter/detector pair can support high speed data transmission at rates in excess above 1 gigabit/second using currently available optoelectronic components. The photo emitters 30a, 32a may be either LEDs (light emitting diodes) or laser diodes such as VCSELs (vertical cavity surface emitting laser). Laser diodes are useful for higher data transmission bandwidths above 500 Mbs. The emitter and detector in each pair may be spaced apart from each other by a free space or air gap, which in most mobile telephone handsets 10 will not exceed 1 centimeter. It may be preferable to mount the photo emitter/receiver pairs spaced apart from each other on the handset 10 to minimize possible optical and electrical cross coupling and interference.

The photo emitter/detectors may be installed in window openings provided in the housings of the body portion 12 and display portion 14, and covered with plastic or other material chosen to be transparent or translucent to the optical wavelengths emitted by the photo detectors 30a, 32a. The windows may be simple flat glass or plastic, or may include a lens of glass or plastic for condensing the optical data signal between emitter and detector.

FIG. 5 illustrates an alternate arrangement of the photo emitter detector sets 30, 32 where the photo emitter/detector pairs are aligned axially along hinge 16. The hinge 16 has a center knuckle 16b attached to display portion 14 and contained between side knuckles 16a, 16c attached to body portion 12. The axis of hinge 16 lies transversely to the knuckles as suggested by line 16x. Opening and closing of the display portion 14 relative to body portion 12 causes center knuckle 16b to rotate relative to side knuckles 16a,b about the hinge axis 16x. Photo emitter 30a and photo detector 30b are mounted on axially opposite sides of side knuckle 16c. Photo detector 32b is shown mounted on center knuckle 16b facing towards and in optical alignment with photo emitter 30a, while photo emitter 32a is supported by any suitable means adjacent to side knuckle 16c facing towards and in optical alignment with photo detector 30b. In this arrangement the photo emitters and photo detectors 30a,b and 32a,b are in continuous optical alignment in both the open and closed conditions of the handset 10. It is understood that the photo emitters and photo detectors 30a,b and 32a,b in FIG. 5 are connected to corresponding driver integrated circuits in a manner analogous to that explained above with respect to FIG. 2a. The spacing between the photo emitter and photo detector of each aligned pair 30, 32 may be very small or negligible, or the photo emitter/detector pair may even be in contact with each other, but nonetheless data transmission takes place by direct illumination of the photo detector by the photo emitter without any intervening optical conduit such as optical fiber.

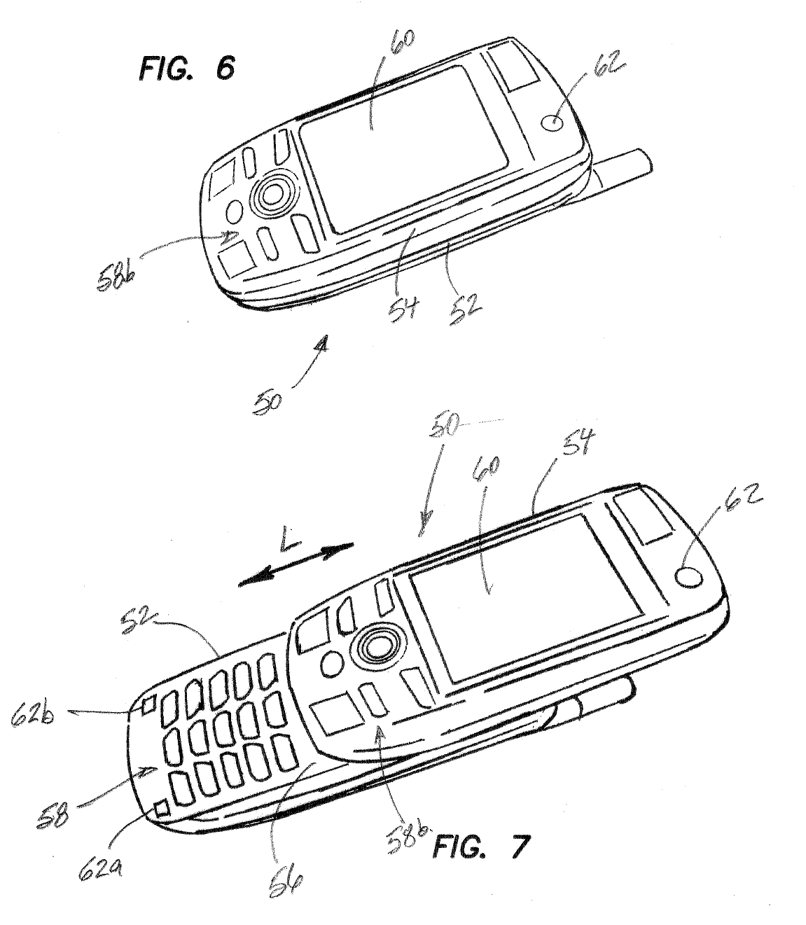

FIGS. 6 and 7 illustrate a typical slide-to-open cellular telephone handset 50, which has a body portion 52 and a display portion 54. In a closed condition of the handset 50 shown in FIG. 6 the display portion 54 directly overlies and largely covers the body portion 52. The handset 50 is deployed for use by linearly sliding the display portion 54 relative to the body portion along mutually facing interior surfaces of the portions 52, 54 along arrow L in FIG. 7. The display portion 54 slides to an extended position to partially expose an interior surface 56 of the body portion 52 on which is installed a keypad 58. Display portion carries an LCD screen 60, a video or still digital camera 62 and additional control buttons 58b.

As shown in FIG. 8, in the slide-to-open handset 50, two sets 62, 64 of photo emitters and photo detectors are provided on inside surface 56 of the body portion 52 and one photo emitter/photo detector set 66 is provided on an opposing inside surface of display portion 54. The photo emitter/photo detector set 66 overlies set 62 in the closed position of handset 50 and overlies set 64 in the open condition of handset 50, as illustrated in FIG. 8. Set 62 includes photo emitter 62a and photo detector 62b. Set 64 includes photo emitter 64a and photo detector 64b. Set 66 includes photo emitter 66a and photo detector 66b. Corresponding driver integrated circuits 68 and receiver integrated circuits 70 are provided for each of the photo emitters and photo detectors, as explained previously in connection with FIGS. 2a through 4. In the closed condition of handset 50, data is transmitted from the display portion 54 to body portion 52 by photo emitter/detector pair 62a,66b, and from display portion 54 to body portion by emitter/detector pair 66a, 62b. In the open condition of handset 50, data is transmitted from the body portion 52 to display portion 54 by photo emitter/detector pair 64a,66b and from display portion 54 to body portion by emitter/detector pair 66a, 64b.

In the arrangements described above the different free space optical interconnections can be supplemented with conventional hard wired connections for those circuits which do not require high bandwidth data rates. In particular, battery power may be supplied from the body portion to the display portion of the handset by means of conductive wires.

While particular embodiments of the invention have been described and illustrated for purposes of clarity and explanation, it will be understood that many changes, modifications and substitutions will be apparent to those having only ordinary skill in the art without thereby departing from the scope and spirit of the invention which is defined by the following claims.

What is claimed is:

1. In a communications handset of the type having first and second portions mutually displaceable between a closed condition and a deployed condition and electronic circuits in each of said portions, the improvement comprising:
at least one light emitting device and at least one light detecting device on each of said portions connected to said circuits and optically aligned across a free space in said closed condition and said deployed condition for providing optical transfer of data between said electronic circuits.

2. The improvement of claim 1 wherein said handset is of the clamshell type wherein said first portion is a body portion with a keypad and said second portion is a display portion hinged to said body portion for movement between said closed condition and said deployed condition.

3. The improvement of claim 1 wherein said handset is of the type wherein said first portion is a body portion and said second portion is a display portion, and said display portion is linearly slidable relative to said body portion between said closed condition and said deployed condition.

4. The improvement of claim 1 wherein said least one light emitting device and said least one light detecting device comprise a first light emitting device and a first light detecting device on each of said portions optically aligned for providing data transfer in said closed condition of said handset and a second light emitting device and a second light detecting device on each of said portions optically aligned for providing data transfer in said deployed condition of said handset.

5. The improvement of claim 1 wherein said portions are hinged to each other and said least one light emitting device and said least one light detecting device are optically aligned generally axially to said hinge.
